(19) United States
(12) Patent Application Publication
(10) Pub. No.: US 2025/0015505 A1
(43) Pub. Date: Jan. 9, 2025

(54) Short antenna having a wide bandwidth

(71) Applicant: KINNERET SMART WAVES LTD. /KSW ANTENNAS, Tiberias (IL)

(72) Inventors: Yaniv Ziv, Tiberias (IL); Matti Martiskainen, Aniam (IL); Sharon Harel, Tiberias (IL)

(21) Appl. No.: 18/711,865

(22) PCT Filed: Nov. 19, 2022
(86) PCT No.: PCT/IB2022/061171

§ 371 Date: May 20, 2024

Related U.S. Application Data
(60) Provisional application No. 63/264,344, filed on Nov. 19, 2021.

(51) Int. Cl. H01Q 13/04; H01Q 9/28

(52) U.S. Cl. CPC H01Q 13/04; H01Q 9/28

(57) ABSTRACT

An antenna unit and an antenna. The antenna may consist essentially of a first hollow truncated cone; and a first inverted hollow truncated cone. The first hollow truncated cone comprises a first base and a first top end. The first inverted hollow truncated cone comprises a second base and a second top end. A radius of the first base may exceed a radius of the second base. The he first top end faces the second top end. The first hollow truncated cone may be spaced apart from the first inverted hollow truncated cone and is electrically isolated from the first inverted truncated cone.

### CROSS REFERENCE

This application claims the benefit of priority from U.S. provisional patent application No. 63/264,344 filing date Nov. 19, 2021, the entire contents of which being incorporated herein in their entirety.

### BACKGROUND

There is a growing need to provide compact wide bandwidth antennas.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the drawings:

FIG. 1 is an example of an antenna;

FIG. 2 is an example of an antenna;

FIG. 3 is an example of an antenna;

FIG. 4 is an example of a combination of antennas;

FIG. 5 is an example of a combination of antennas;

FIG. 6 is an example of a VSWR of a first antenna;

FIG. 7 is an example of a VSWR of a second antenna;

FIG. 8 is an example of an antenna unit;

FIG. 9 is an example of an antenna;

FIG. 10 is an example of a method; and

FIG. 11 is an example of a method.

### DETAILED DESCRIPTION OF THE DRAWINGS

In the following detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method.

Any reference in the specification to a system should be applied mutatis mutandis to a method that may be executed by the system.

The term “and/or” means additionally or alternatively.

Any dimensions and/or frequencies referred to in the figures and/or the specification are provided as non-limiting examples. The dimensions and/or relationships between dimensions may deviate from those illustrated in the figures and/or specification. The figures me or may not be in scale. The frequencies and/or relationships between frequencies may deviate from those illustrated in the figures and/or specification.

Any one of the terms “substantially equals” or “about” may cover a deviation up to 5, 10, 15, 20 percent or up to 5, 10, 15 degrees.

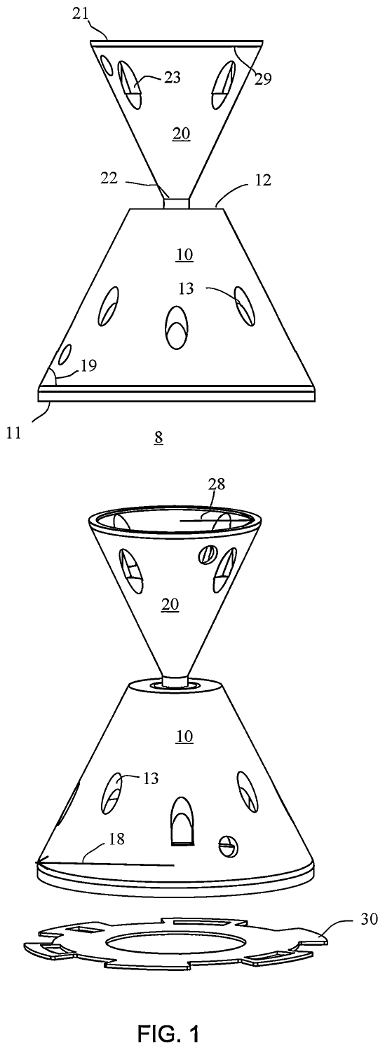

There may be provided an antenna (referred to as a first antenna) and antenna unit. The antenna unit may include a first antenna. The first antenna may include of a first hollow truncated cone and a first inverted hollow truncated cone. The first inverted hollow truncated cone is termed inverted as it is inverted in relation to the first follow truncated cone. See, FIG. 1 that illustrates first antenna 8 that includes first hollow truncated cone 10 and a first inverted hollow truncated cone 20.

The first hollow truncated cone may include a first base and a first top end. The first inverted hollow truncated cone includes a second base and a second top end. See, for example, FIG. 1 that illustrates first base 11, first top end 12, second base 21 and second top end 22. It should be noted that the terms base and top are used to differentiate between the larger end (base) and the smaller end (top) of any of the hollow truncated condes. The base is not necessarily located at a higher position than the top.

The radius of the first base may exceeds a radius of the second base.

The height of the first hollow truncated cone may substantially equal the height of the first inverted hollow truncated cone.

The first top end faces the second top end in the sense that the first top end is a part of the first hollow truncated cone that is closest to the first inverted hollow truncated cone, and that the second top end is a part of the first inverted hollow truncated cone that is closest to the first hollow truncated cone,

The first top end may be substantially parallel to the second top end.

An axis of symmetry of the first hollow truncated cone and an axis of symmetry of the first inverted hollow truncated cone may be located at a same location but at different heights.

The first hollow truncated cone may electrically isolated from the first inverted hollow truncated cone.

The first hollow truncated cone may be spaced apart from the first inverted hollow truncated cone.

The first hollow truncated cone may be parallel to the first inverted truncated cone.

The base angle (denoted 19 in FIG. 1) of the first hollow truncated cone may be substantially equal to a base angle (denoted 29 in FIG. 1) of the first inverted truncated cone.

The radius of the first top end may exceed a radius of the second top end.

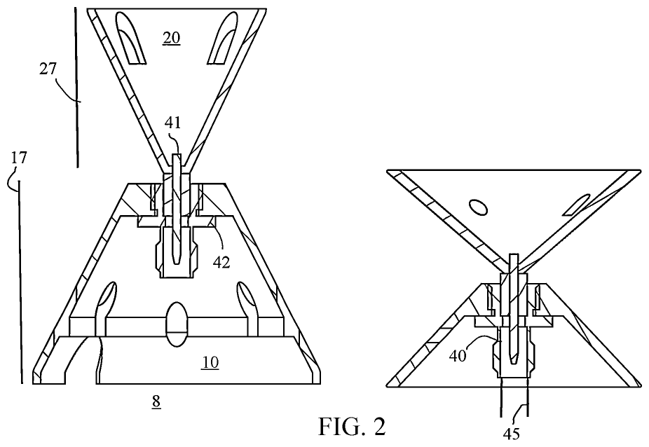

The antenna unit may include a coaxial cable connector (denoted 40 in FIG. 2). The first conductor (also referred to as core—and is denoted 41 in FIG. 2) of the coaxial cable connector may be electrically coupled to the first hollow truncated cone and the second conductor (denoted 42 in FIG. 2) of the coaxial cable connector may be electrically coupled to the first inverted truncated cone. The coaxial cable connected is electrically coupled to coaxial cable (denoted 45 in FIG. 2).

The height of the first antenna may range between 4 and 8 centimeters—for example may be substantially equal 6.3 centimeters.

The height (denoted 17 in FIG. 2) of the first hollow truncated cone may be substantially equal a height (denoted 27 in FIG. 2) of the first inverted truncated cone.

The radius of the first base (denoted 18 in FIG. 1) exceeds the radius of the second base (denoted 28 in FIG. 1) by a factor that ranges between 1.3 to 1.9. For example—the radius of the first base may be about 2.2 centimeters and the radius of the second base may be about 1.35 centimeters.

The radius of the first base may range between 1.8 and 2.5 centimeters. For example—the radius of the first base may be about 2.2 centimeters.

The antenna unit may include a conductive reflector (denoted 30 in FIG. 1) that is spaced apart from the first base and faces the first base. The conductive reflector may have a central aperture and may include various protuberances that may be used for mechanically interfacing with the conductive reflector.

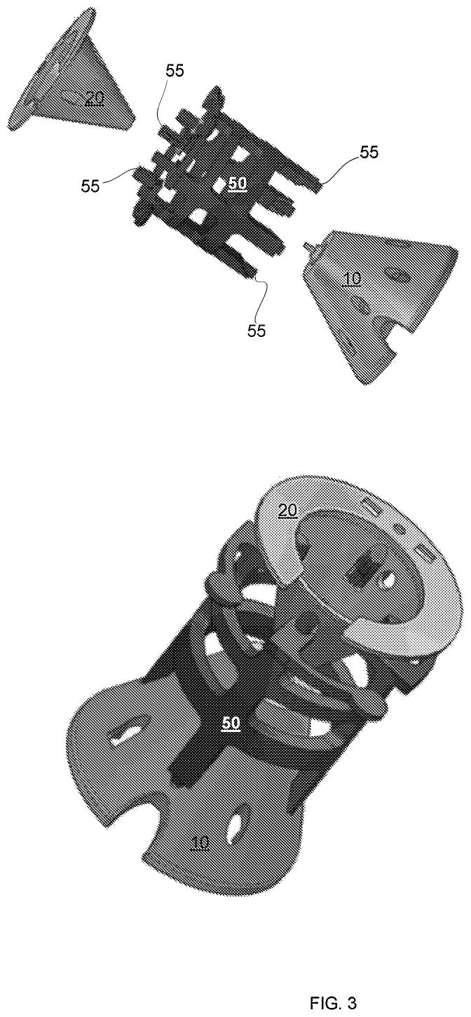

The antenna unit may include a spacer (denoted 50 in FIG. 3) for maintaining a space between the first hollow truncated cone and the first inverted hollow truncated cone. The space assists in providing an electric isolation between the first hollow truncated cone and the first inverted hollow truncated cone.

The first hollow truncated cone and the first inverted hollow truncated cone may include one or more recesses (denoted 13 and 23 respectively in FIG. 1) for interfacing with one or more protuberances (denoted 55 in FIG. 3) of the spacer.

The first antenna may exhibit a wide bandwidth. For example—the first antenna may radiate radiation between 1 Ghz and 6 GHZ. The first antenna is very compact and has a height that is less than half of a height of a dipole antenna for transmitting the low end (1 Ghz) of the wide frequency range. For example, the height of the first antenna may be about 6.2 cm—much shorter than the height of 15 cm of the diploe antenna.

The short height of the first antenna may be attributed to the first hollow truncated cone and the first inverted hollow truncated cone—especially when having significant diameters—in contrary to an elongated dipole of small cross section.

The first antenna is both short and has a very wide bandwidth.

The difference in the measurements of the first hollow truncated cone and the first inverted hollow truncated cone allows the first hollow truncated cone to radiate in a sub-range of frequencies that differs from a sub-range of radiation of the inverted hollow truncated cone. The sub-ranges may partially overlap or may not overlap.

The top end of the first hollow truncated cone improves the radiation of electromagnetic energy at a high end of the very wide bandwidth—in comparison to radiating by a non-truncated cone.

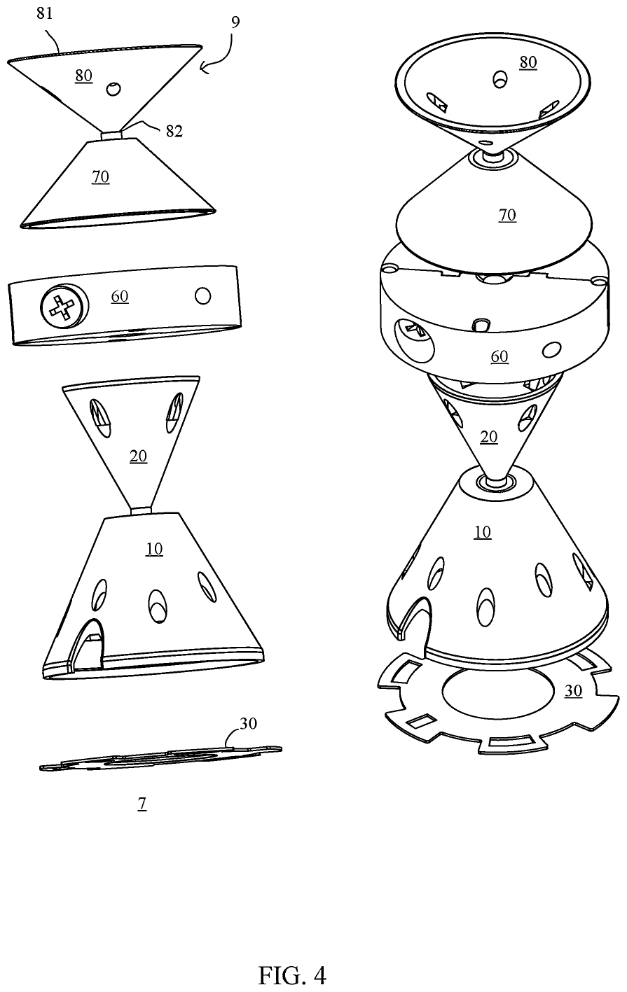

The antenna unit may include a second antenna (denoted 9 in FIG. 4) that is isolated from the first antenna. The combination of the first and second antennas is denoted 7 in FIG. 4.

The second antenna may exhibit a bandwidth that is narrower than the bandwidth of the first antenna. For example—the second antenna may radiate radiation between 2.4 GHz and 5.8 GHz. This may overlap the Wi-Fi frequency bands.

The second antenna (see FIG. 4) may include a second hollow truncated cone 70 and a second inverted hollow truncated cone 80. The second hollow truncated cone may include a third base 71 and a third top end 72. The second inverted hollow truncated cone may include a fourth base 81 and a fourth top end 82. A radius of the third base substantially equals a radius of the fourth base. A radius of the third top end may exceed a radius of the fourth top end.

The second hollow truncated cone may be spaced apart from the second inverted hollow truncated cone and is electrically isolated from the second inverted truncated cone. This may be obtained by using mechanical support element such as a spacer.

A height of the second hollow truncated cone may be substantially equal to the height of the second inverted hollow truncated cone. For example—the height may range between 1 and 3 centimeters—for example be about 1.7 cm. The radiuses of the second hollow truncated cone and the second inverted hollow truncated cone may range between 1.5 and 3 cm—for example may be 2 cm.

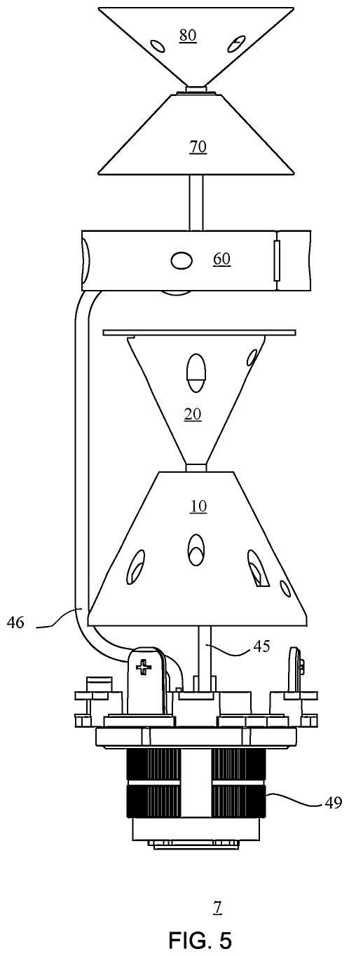

The antenna unit may include a dielectric disc (denoted 60 in FIGS. 4 and 5) that is positioned between the first antenna and the second antenna. The thickness of the dielectric disk may range between 0.5 and 2.5 cm—for example may be 1.5 cm.

The dielectric disc may be spaced apart from each one of the first antenna and the second antenna. The spacing may be obtain by using any mechanical support element such as a spacer. The distances between the dielectric disc and each one of the first and second antennas may change the impact of the dielectric disc on either one of the first and second antennas. The distance between the dielectric disc and the first antenna may range between 0.2 and 1 cm—for example may be 0.6 cm. The distance between the dielectric disc and the second antenna may range between 0.7 and 1.5 cm—for example may be 1 cm. The distance between the dielectric disc and the first antenna may be smaller than the distance between the dielectric disc and the second antenna.

The antenna unit may include a second coaxial connector 45 and a second coaxial cable 46 that extends from the second coaxial connector. The second coaxial cable may contact the dielectric disc, may bypass the dielectric disc or may pass through the dielectric disc.

The second coaxial cable may be used to feed the second antenna via a second coaxial cable connector. A first conductor of the second coaxial cable connector may be electrically coupled to the second hollow truncated cone and a second conductor of the second coaxial cable connector may be electrically coupled to the second inverted truncated cone.

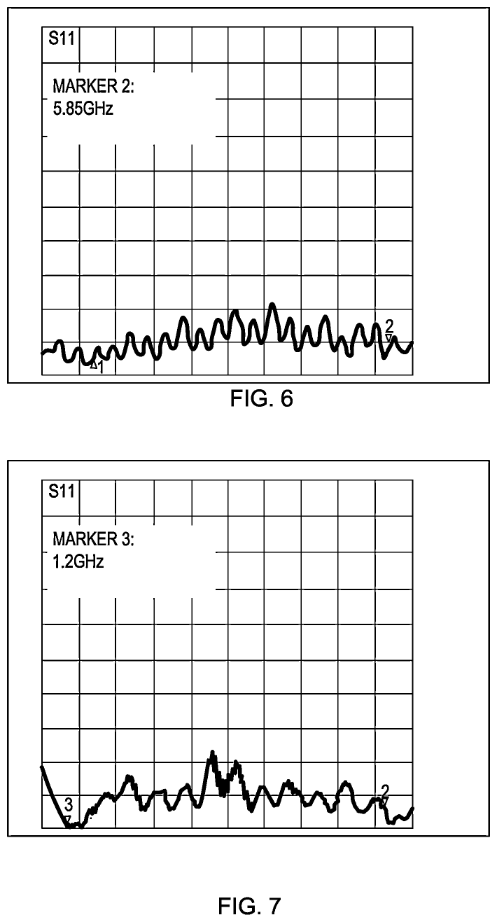

FIG. 6 is an example 98 of a VSWR of a first antenna.

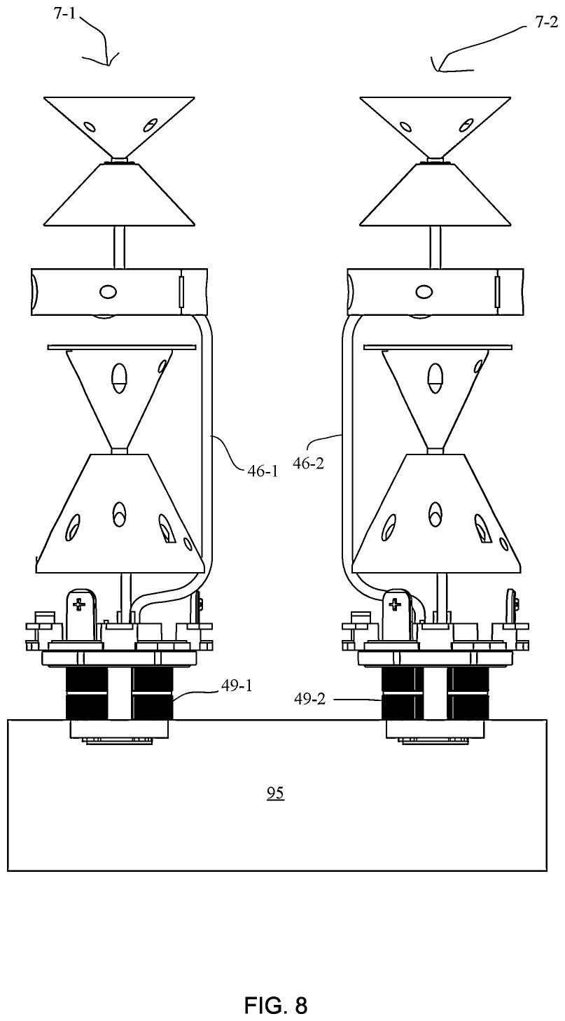

FIG. 7 is an example 99 of a VSWR of a second antenna.

The antenna unit may include one or more instances of the first antenna and/or one or more instances of a combination of the first antenna and the second antenna. See. For example FIG. 8 that illustrates radio device that includes two coaxial connectors 45-1 and 45-2 that feed (or may be fed by) two combinations 7-1 and 7-2 of two antennas each.

In FIG. 8, the second coaxial cables of two adjacent instances of combination may face each other—to provide a minimal disturbance to the omnidirectional radiation pattern of each combination. Other arrangements of the second coaxial cable may introduce more disturbances.

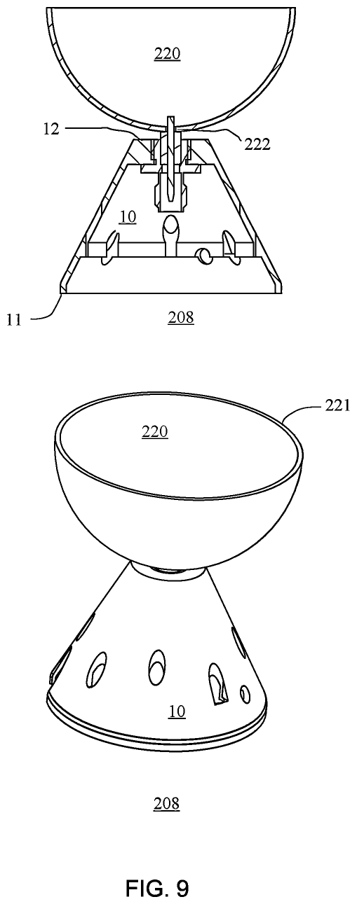

It should be noted that the first antenna may be replaced by an antenna that includes a hollow truncated cone and a half-sphere—this is illustrated in FIG. 9—in which the first inverted hollow truncated cone is replaced by a hollow half-sphere 220 that includes a half-sphere base 221 and a half-sphere top end 222. The first hollow truncated cone top end 12 faces the half-sphere base 222. The first hollow truncated cone 10 is spaced apart from the half-sphere and is electrically isolated from the half-sphere. It should be noted that the first hollow truncated cone (and not the first inverted hollow truncated cone) may be replaced by a hollow half-sphere.

The half-sphere, the second hollow truncated cone, the second inverted hollow truncated cone, the first hollow truncated cone and the first inverted hollow truncated cone are electrically conductive.

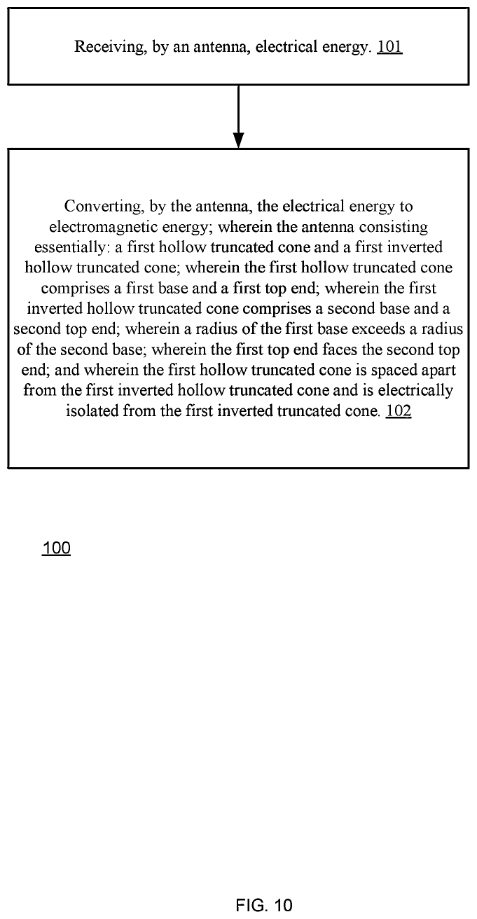

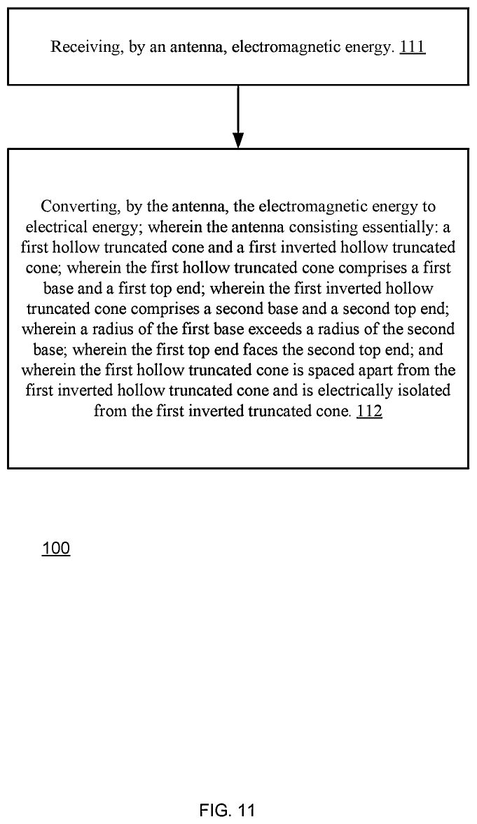

FIG. 10 illustrates an example of a method 100 for radiation transmission.

Method 100 may include step 102 of receiving, by an antenna, electrical energy.

Step 102 may be followed by step 104 of converting, by the antenna, the electrical energy to electromagnetic energy; wherein the antenna consisting essentially: a first hollow truncated cone and a first inverted hollow truncated cone; wherein the first hollow truncated cone comprises a first base and a first top end; wherein the first inverted hollow truncated cone comprises a second base and a second top end; wherein a radius of the first base exceeds a radius of the second base; wherein the first top end faces the second top end; and wherein the first hollow truncated cone is spaced apart from the first inverted hollow truncated cone and is electrically isolated from the first inverted truncated cone.

FIG. 11 illustrates an example of a method 110 for radiation transmission.

Method 110 may include step 112 of receiving, by an antenna, electromagnetic energy.

Step 112 may be followed by step 114 of converting, by the antenna, the electromagnetic energy to electrical energy. The antenna consisting essentially of a first hollow truncated cone and a first inverted hollow truncated cone; wherein the first hollow truncated cone comprises a first base and a first top end; wherein the first inverted hollow truncated cone comprises a second base and a second top end; wherein a radius of the first base exceeds a radius of the second base; wherein the first top end faces the second top end; and wherein the first hollow truncated cone is spaced apart from the first inverted hollow truncated cone and is electrically isolated from the first inverted truncated cone.

Method 100 and/or method 110 may be applied, mutatis mutandis to any of the antennas illustrated in the application—for example to the combination of first and second antennas and/or to an antenna that include the hollow half-sphere.

Any reference to including or having or comprising should be applied mutatis mutandis to consisting essentially of and/or should be applied mutatis mutandis to consisting.

Any reference to consisting should be applied mutatis mutandis to consisting essentially of and/or should be applied mutatis mutandis to comprising or having or including.

Any reference to consisting essentially of should be applied mutatis mutandis to consisting and/or should be applied mutatis mutandis to comprising or having or including.

Consisting essentially of limits the scope of a content that follows this transitional phase to the specified elements listed in the content and those that do not materially affect the basic and novel characteristic(s) of the content.

Consisting limits the scope of a content that follows this transitional phase to the specified elements listed in the content.

Comprising is inclusive or open-ended and does not exclude additional elements to the content that follows this transitional phase.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments of the disclosure s containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiments of the disclosure.

We claim:

1. An antenna unit, the antenna unit comprising:
a first antenna; wherein the first antenna comprises a first hollow truncated cone and a first inverted hollow truncated cone;
wherein the first hollow truncated cone comprises a first base and a first top end;
wherein the first inverted hollow truncated cone comprises a second base and a second top end;
wherein a radius of the first base exceeds a radius of the second base;
wherein the first top end faces the second top end; and
wherein the first hollow truncated cone is spaced apart from the first inverted hollow truncated cone and is electrically isolated from the first inverted truncated cone.

2. The antenna unit according to claim 1, wherein the first hollow truncated cone is parallel to the first inverted truncated cone.

3. The antenna unit according to claim 1, wherein a base angle of the first hollow truncated cone is substantially equal to a base angle of the first inverted truncated cone.

4. The antenna unit according to claim 1, wherein a radius of the first top end excessed a radius of the second top end.

5. The antenna unit according to claim 1, comprising a coaxial cable connector, wherein a first conductor of the coaxial cable connector is electrically coupled to the first hollow truncated cone and a second conductor of the coaxial cable connector is electrically coupled to the first inverted truncated cone.

6. The antenna unit according to claim 1, wherein a height of the first antenna ranges between 4 and 8 centimeters.

7. The antenna unit according to claim 1, wherein a height of the first hollow truncated cone substantially equals a height of the first inverted truncated cone.

8. The antenna unit according to claim 1, wherein the radius of the first base exceeds the radius of the second base by a factor that ranges between 1.3 to 1.9.

9. The antenna unit according to claim 1, wherein the radius of the first base ranges between 1.8 and 2.5 centimeters.

10. The antenna unit according to claim 1, further comprising a conductive reflector that is spaced apart from the first base and faces the first base.

11. The antenna unit according to claim 1, further comprising a spacer for maintaining a space between the first hollow truncated cone and the first inverted hollow truncated cone.

12. The antenna unit according to claim 11, wherein the first hollow truncated cone and the first inverted hollow truncated cone comprise one or more recesses for interfacing with one or more protuberances of the spacer.

13. The antenna unit according to claim 1, further comprising a second antenna that is isolated from the first antenna.

14. The antenna unit according to claim 13, wherein the second antenna comprises a second hollow truncated cone and a second inverted hollow truncated cone;
wherein the second hollow truncated cone comprises a third base and a third top end;
wherein the second inverted hollow truncated cone comprises a fourth base and a fourth top end;
wherein a radius of the third base substantially equals a radius of the fourth base;
wherein a radius of the third top end exceeds a radius of the fourth top end; and
wherein the second hollow truncated cone is spaced apart from the second inverted hollow truncated cone and is electrically isolated from the second inverted truncated cone.

15. The antenna unit according to claim 14, comprising a dielectric disc that is positioned between the first antenna and the second antenna.

16. The antenna unit according to claim 15, wherein the dielectric disc is spaced apart from each one of the first antenna and the second antenna.

17. The antenna unit according to claim 14, comprising a second coaxial connector and a second coaxial cable that passes through the dielectric disc.

18. The antenna unit according to claim 13, comprising a second coaxial connector and a second coaxial cable.

19. The antenna unit according to claim 1, comprising an additional antenna; wherein the additional antenna comprises an additional hollow truncated cone and an additional inverted hollow truncated cone.

20. An antenna, the antenna consisting essentially of:
a first hollow truncated cone; and
a first inverted hollow truncated cone;
wherein the first hollow truncated cone comprises a first base and a first top end;
wherein the first inverted hollow truncated cone comprises a second base and a second top end;
wherein a radius of the first base exceeds a radius of the second base;
wherein the first top end faces the second top end; and
wherein the first hollow truncated cone is spaced apart from the first inverted hollow truncated cone and is electrically isolated from the first inverted truncated cone.

21. A method for radiation transmission, the method comprises:
receiving, by an antenna, electrical energy; and
converting, by the antenna, the electrical energy to electromagnetic energy;
wherein the antenna consisting essentially: a first hollow truncated cone and
a first inverted hollow truncated cone; wherein the first hollow truncated cone comprises a first base and a first top end; wherein the first inverted hollow truncated cone comprises a second base and a second top end; wherein a radius of the first base exceeds a radius of the second base; wherein the first top end faces the second top end; and wherein the first hollow truncated cone is spaced apart from the first inverted hollow truncated cone and is electrically isolated from the first inverted truncated cone.

22. An antenna, the antenna consisting essentially of:
a hollow truncated cone; and
a half-sphere;
wherein the hollow truncated cone comprises a hollow truncated cone base and a hollow truncated cone top end;
wherein the half-sphere comprises a half-sphere base and a half-sphere top end;
wherein the hollow truncated cone top end faces the half-sphere base; and
wherein the hollow truncated cone is spaced apart from the half-sphere and is electrically isolated from the half-sphere.

23. An antenna unit, the antenna unit comprising:
a first antenna; wherein the antenna consisting essentially of a hollow truncated cone; and a half-sphere; wherein the hollow truncated cone comprises a hollow truncated cone base and a hollow truncated cone top end; wherein the half-sphere comprises a half-sphere base and a half-sphere top end; wherein the hollow truncated cone top end faces the half-sphere base; and wherein the hollow truncated cone is spaced apart from the half-sphere and is electrically isolated from the half-sphere.
